(19) United States
(12) Patent Application Publication
(10) Pub. No.: US 2026/0249429 A1
(43) Pub. Date: Aug. 27, 2026

(54) TWEEZER ASSEMBLY

(71) Applicant: Ramon Frederick Richardson, Bude (GB)

(72) Inventor: Ramon Frederick Richardson, Bude (GB)

(21) Appl. No.: 19/059,435

(22) Filed: Feb. 21, 2025

(51) Int. Cl. B25B 9/02; A45D 26/00

(52) U.S. Cl. CPC B25B 9/02; A45D 26/0066; A45D 2026/008

(57) ABSTRACT

A tweezer assembly provided as a substantially flat form comprises at least four adjacent side wall panels hinged to each other, first and second tweezer arms each extending from a respective side wall panel, and a cap or lid panel hinged or attachable to at least one side wall panel. The side wall panels are closable onto one another to form a three dimensional tweezer body with the tweezer arms at opposite sides of the body. The cap is disposed in abutment with the side wall panels and in an orientation substantially orthogonal to a longitudinal axis of the tweezer assembly. A magnifying lens is disposed in or on the lid panel.

### TECHNICAL FIELD

The present invention relates to a tweezer assembly.

### BACKGROUND TO THE INVENTION

Tweezers are a commonly used tool in several settings: in the home, for the removal of hairs or splinters, in the beauty industry, in the laboratory, in manipulating small articles and specimens, in classrooms and the like. It is known to have tweezers provided with a magnifying lens.

Some examples of prior art tweezers provided with a magnifying lens are disclosed in the applicant's earlier WO-94/28806, as well as in US-2009/021033, U.S. Pat. No. 3,744,883 and CN-111,283,567.

### SUMMARY OF THE PRESENT INVENTION

The present invention seeks to provide an improved tweezer assembly.

According to an aspect of the present invention, there is provided a pair of tweezers provided as a substantially flat form comprising at least four adjacent side wall panels hinged to each other, first and second tweezer arms each extending from a respective side panel, and a lid panel hinged or attachable to at least one side panel, the lid panel comprising a magnifying lens; wherein the side wall panels are closable to form a three dimensional tweezer body member with the tweezer arms at opposite sides of the body member, and wherein the lid panel is disposed over the wall side panels and in an orientation substantially orthogonal to a longitudinal axis of the tweezers, the magnifying lens having an axis of focus substantially aligned with the longitudinal axis of the tweezers and a focal point at or adjacent ends of the tweezer arms.

The tweezer assembly can be provided as a flat package, easier to transport and keep, and can be configured to its three dimensional in-use form. In the preferred embodiments, the assembly can be decoupled from its three dimensional form so as to be able to be returned back to its substantially flat form. Another advantage with this arrangement is that the tweezers, after use, can be opened out again, into their substantially flat form, allowing them to be readily cleaned for reuse. This can save having to dispose of the tweezers after use, which is currently practiced in some applications, such as in medical environments.

Preferably, the lens is integral with or attached to the lid panel.

The side wall panels are preferably formed integrally together in side-by-side arrangement, two of the side panels being respective ends of the side-by-side arrangement and each having an unconnected edge, each unconnected edge comprising an attachment feature such that the two end panels can be connected together.

Adjacent side wall panels may be connected to one another by a foldable coupling. Each foldable coupling is advantageously formed by a bendable part of material forming the tweezer body.

In an embodiment, the lens is attachable to the cap and the assembly comprises a plurality of lenses of different focal magnifying power, one of which is selectable to attachment to the cap.

Advantageously, the lid panel and the lens are integral with one another.

There may be provided a finger grip at an outer surface of each tweezer arm.

In some embodiments, the side wall panels and tweezer arms are formed as a unitary component.

The tweezer body is preferably substantially square or rectangular in transverse cross-section.

The first and second longitudinal axes of the tweezers preferably extend substantially parallel to one another when in the assembled form.

In another embodiment, the first and second longitudinal axes of the tweezers taper towards one another, and may curve towards one another.

In the preferred embodiments, each tweezer arm comprises an internal rib extending in a longitudinal direction of the tweezer arm. Each internal rib may taper from the tweezer body to the tip of the tweezer arm.

Advantageously, each internal rib comprises an upper shoulder able to support the lid panel.

Preferably, the side wall panels are releasably connectable to one another, allowing the tweezers to be opened up to the flat configuration.

The pair of tweezers may incorporate or be coated with an anti-bacterial agent.

In some embodiments, the lens is attachable to the cap and the assembly comprises a plurality of lenses of different magnifying power, one of which being selectable for attachment to the cap panel.

Advantageously, at least a portion of an outside face of at least one of the tweezer arms is textured, ribbed or knurled.

In some embodiments, the first and second tweezer arms extend substantially parallel to one another when in the assembled form. With this arrangement, a user can have a clear line of sight through the lens to the entire area of the lens, facilitating use of the tweezers.

The lens is preferably positioned to have a principal axis running substantially parallel to a longitudinal axis of the tweezers when configured. As such, a magnified image of the area between the tweezer legs is transmitted along a user's line of sight.

In some embodiments, the lid panel includes an aperture into which a magnifying lens, provided as a separate unit, can be placed. In other embodiments, the magnifying lens itself may form a cap panel which is hinged to or attachable to at least one body member.

In other embodiments, there may be provided more than four side panels hinged to each other. For example, six side panels may be provided to form a tweezer body of substantially hexagonal transverse cross-section.

Joining edges of the side panels are preferably of a thinner or otherwise less rigid construction or composition, to allow for bending.

There is also disclosed a method of configuring a pair of tweezers from a substantially flat form, wherein the tweezers are formed by folding material between adjacent side panels such that the two tweezer arms extend from opposing side panels. Preferably, such method of assembly may be carried out by hand, without the need for tools or undue force.

The preferred embodiments can provide a tweezer assembly that can, with or without the lens, be manufactured as a single substantially flat sheet component, which enables time, material and potentially cost effective methods such as injection moulding or additive manufacturing to be employed. An advantageous aspect of this is that the assembly can be packaged substantially flat and delivered as a letter-sized envelope, for example. Furthermore, the provision of substantially parallel tweezer arms in some embodiments means that, upon configuring into tweezers, there is a substantial distance between gripping ends, thus increasing the view of objects which may be manipulated. Furthermore, the provision of a separate, attachable lens in some of the preferred embodiments provides scope for a range of magnifying lenses to be used interchangeably, depending on the user's needs.

Other aspects and advantages of the teachings herein will become apparent to a person skilled in the art from the description that follows.

### BRIEF DESCRIPTION OF THE DRAWINGS

Embodiments of the present invention are described below, by way of example only, with reference to the accompanying drawings, in which:

FIG. 1 is a schematic diagram of the inside view of a 2-D blank model configured to form an embodiment of tweezer assembly;

FIG. 2 is a schematic left side view of the tweezer blank of FIG. 1;

FIG. 3 shows a contrary schematic right side view of the tweezer blank of FIG. 1;

FIG. 4 is a schematic diagram of the outside view of the embodiment of tweezer blank of FIG. 1;

FIG. 5 is a schematic side view of an embodiment of tweezers in fully assembled form;

FIG. 6 is a plan elevational view of a preferred embodiment of tweezer blank, when in an opened, flattened, condition;

FIG. 7 is a perspective view from above of the embodiment tweezer blank of FIG. 6;

FIG. 8 is a perspective view from below of the embodiment of tweezer blank of FIG. 6;

FIG. 9 is an end view of the embodiment of tweezer blank of FIG. 6 in the flattened condition;

FIG. 10 is a perspective view of the embodiment of tweezer blank of FIGS. 6 to 9, showing the tweezer blank in a closed, in-use, condition;

FIG. 11 is a longitudinal perspective view of the configured tweezers of FIG. 10;

FIG. 12 is a cross sectional view taken along line A-A of FIG. 11;

FIG. 13 is a side elevational view of the tweezers of FIGS. 11 to 12, in the configured format;

FIG. 14 is and end elevational view of the tweezers of FIGS. 10 to 13;

FIG. 15 is a cross sectional view of the tweezers of FIG. 14 along line B-B;

FIG. 16 is an enlarged view of section C of the head of the tweezers of FIG. 15;

FIG. 17 is an end elevational view from the tweezer tips of the tweezers of FIGS. 10 to 16; and

FIGS. 18 and 19 show another embodiment of tweezers.

### DESCRIPTION OF THE PREFERRED EMBODIMENTS

The preferred embodiments and aspects disclosed herein provide a pair of tweezers configurable from a substantially flat blank or net, with a magnifying lens disposed so as to provide magnification of the view at the tweezer arm tips, as well as a method of configuring the tweezers.

FIGS. 1 to 5 show generalised embodiments of a tweezer assembly according to the teachings herein. FIGS. 6 to 17 show details of a production version of tweezers according to the teachings herein.

FIG. 1 shows an inside view of an embodiment of tweezer blank or net 100, in an open, or unconfigured, state.

In the preferred embodiment the blank or net 100 is formed primarily of a unitary material comprising a plurality of elements formed integrally with one another.

With reference to the embodiment shown in FIG. 1, the blank 10 comprises four substantially rectangular side panels 110 disposed in side-by-side relation along their longitudinal edges. Each panel 110 is preferably flat, although may in other embodiments be curved. Adjacent side panels 110 are connected to one another by hinges 111, which may be weakened regions of the material forming the blank 100. The hinges may, for example, be regions of reduced thickness, score lines along the material forming the blank or have any other form enabling them to act as a hinge.

Extending from two side panels 110 are first and second tweezer arms 120, which in this embodiment are formed integrally with their respective side panel 110. As can be seen in FIG. 1, the tweezer arms 120 preferably taper from the respective side panel 110 to a narrow end 122, although this is an optional feature. The tweezer arms 120 could in other embodiments be substantially straight or may even taper outwardly to have wider free ends relative to the other end of each tweezer arm.

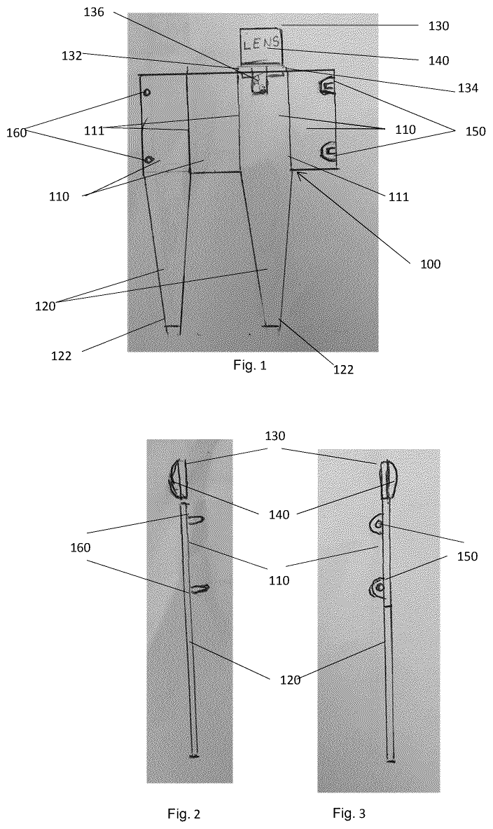

With reference also to FIG. 2, at one side of the blank 100, formed in this example integrally with one of the side panels 110, at its free side, are a pair of bosses or pins 160, spaced from one another along the longitudinal free edge of the side panel and which in this embodiment extend substantially perpendicular to the plane of the side panel. With reference to FIG. 3, this shows a side elevational view of the opposing side panel free edge, having in this embodiment first and second loops 150 at the side panel free edge and spaced from one another by a spacing equivalent to that of the pins 160. Each loop 150 has an opening sized to receive a respective pin 160. The pins and loops are preferably formed integrally with the blank 110 and preferably are also of the same material.

Disposed at what could be described as an upper end of the blank 100 and at one of the side panels 100 there is provided a coupling element 132 which in this embodiment includes a hinged base 134 formed integrally with a boss 136 which attaches to a respective side panel 110. The attachment may be into an associated recess in the side panel 110 or may be attached to a surface of the side panel 110. Connected to the hinged coupling 134 is a cap 130 which incorporates a lens 140. In this embodiment, the cap 130 and lens 140 preferably have a rectangular shape in plan view (as seen in FIG. 1), although the optical part of the lens 140 is preferably round in conventional manner. The lens 140 may in some embodiments be attached to a cap in the form of a flat translucent or transparent panel, may fit within an appropriately shaped and sized aperture in the cap, or may be formed integrally with the cap 130 as a unitary element.

It is envisaged in some embodiments that the coupling 134 could be removable from the side panel assembly and attachable thereto by a user. This would enable the user to select a particular lens for their use, potentially from a plurality of lenses supplied with the assembly, with the lenses being of different magnification for example.

With reference to FIGS. 2 and 3, it can be seen in this embodiment that the tweezer arms 120 are co-planar with their respective side panel. In other embodiments, the tweezer arms 120 may extend at an angle to the respective side panel, for example to extend or curve inwardly or outwardly of the configured tweezer assembly, as described in further detail below.

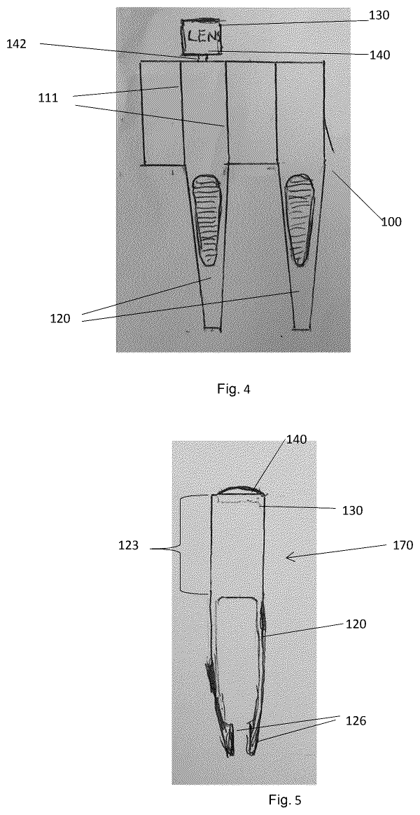

Referring now to FIG. 4, this shows what could be described as an outer side of the blank 100 shown in FIG. 1. In the preferred embodiment, each tweezer arm 120 is provided with a textured, ribbed or knurled zone 124, or finger grip, to facilitate gripping and use of the tweezers 100.

In the view of FIG. 4, the lens 140 is shown connected to a coupling element having a neck 142, rather than a hinged connector extending across the width of the cap 130.

In the embodiments shown in FIGS. 1 to 4, the blank is of a substantially flat form, such that each side panel and the tweezer arms are also substantially flat. It is envisaged in other embodiments that the side panels and/or the tweezer arms could be made to have a slight curvature in transverse cross-section, even up to being quarter circular when viewed in transverse-cross-section, such that the body member instead of having a flat rectangular cuboid form has a more rounded cylindrical form.

Referring now to FIG. 5, this shows the assembly of FIGS. 1 to 4 in the assembled form. In order to reach this configuration, the side panels 110 of the blank 100 are formed around one another such that the connecting elements 150, 160 are coupled to one another, thereby forming a three-dimensional tweezer. The side panels 110 form a tweezer body member 170 which, in the embodiments shown, will be substantially square in transverse-cross-section. The tweezer arms 120, being located at alternate side panels 110, will be disposed opposite one another in the finished tweezer assembly, as will be apparent from FIG. 5. The cap 130 can be pivoted by 90° relative to its position in the blank, so as to lie across the body member 170 and thereby be bounded at each of its sides by a respective side panel 110. The cap 130 may attach to body member 170, for example into an appropriate channel or recess (not shown) formed at the top of each side panel 110, or may be glued thereto. The cap can give structural strength and integrity to the body member 170.

As will be apparent from FIG. 5, when assembled, the side panels 110 form a body member which is substantially square and the lens 140 is disposed as to have its focal axis parallel and preferably in the middle of the longitudinal axis of the final assembly. The lens 140 is preferably chosen so as to have a focal point at the distal ends 122 of the tweezer arms 120, that is at the operative location of the tweezers 100.

Advantageously, the lens 140 and the tweezer arms 120 are configured such that the overall length of the tweezers from the lens 140 to the tips of the tweezer arms 120 is the same as the focal length of the lens. In practical embodiments, the tweezers may have a length of 50, 75 or 100 millimetres.

It is preferred that the assembly is able to be opened up again, to return it to the blank form shown in FIGS. 1 and 4, in which the case the couplings 150, 160 are preferably releasable couplings. In other embodiments, the assembly could be fixable in non-releasable manner, in which case the couplings 150, 160 could be one way couplings, for example using a snap-fit coupling or the like.

In the embodiment of FIG. 5, the tweezer arms 120, as well as being curved towards one another, especially at their distal ends, are provided with thickened pad elements 126 having parallel opposing faces, which may in some embodiments be textured, and in other embodiments may be smooth. All embodiments of the tweezer assembly contemplated herein may have pads of this nature.

An assembly having a square body 170, as well as providing a blank which can be substantially flat and therefore easier to transport and store, also provides a shape of tweezer which can be easier to hold and manipulate, especially compared to rounded tweezers, such that those having a lens.

The tweezers are preferably made of a flexible material. They may be made of a plastics material, metal, metal alloy or the like. In the preferred embodiments, the tweezer assembly is made of or coated with an anti-bacterial or antimicrobial plastics or polymer material, which enables the tweezers to be wiped clean for reuse and save on having to dispose of used tweezers. The material is, though, preferably rigid enough that the body member 170 is substantially solid and immovable, to provide strength and facilitate usage. In this regard, in some embodiments, the side panels 120 may be thicker than the tweezer arms 120 to provide differences in rigidity and flexibility, respectively.

The flat side panels 110, and indeed being able to flatten the whole blank, also makes it easier to print on the side panels 110, for instance instructions, logos or other printed matter.

It will be appreciated that other ways of connecting the free sides of the side panels to one another to form the body 170 may be provided instead of the pins and hooks shown in the embodiments in the drawings. It is also envisaged that in place of a dedicated a connector arrangement, the free edges could in some embodiments simply be glued to one another, although this is not preferable as a mechanical connection between the two free edges can provide a more secure and robust connection and therefore body member.

The cap and lens 130, 140 are shown to be located at the distal end of the assembly, closest to the user when operating the tweezers. It is not excluded that the lens and/or cap could be disposed anywhere along the length of the body member 170.

In some embodiments the lens 140 may be replaceable with lenses of different magnifying power. The magnifying lens enables better viewing of the object held between the legs 120 through magnification and enables increased gripping precision which potentially enables higher accuracy and quality of work.

Referring now to FIGS. 6 to 17, these show a preferred embodiment of a tweezer blank and tweezers 200 according to the teachings herein. The embodiment shown in these Figures is preferably made of a unitary blank of plastics material but in other embodiments could be made of a plurality of different components which are connected together during assembly. For example, the lens in some embodiments could be made as a separate component which is then fitted to the cover or lid panel of the structure, while in other embodiments the lens may be formed integrally and unitary with the tweezer blank.

In accordance with the teachings above, the tweezer blank is preferably of a form that is provided is substantially flat configuration prior to making up the tweezers, and may also be subsequently re-openable to be returned to a substantially flat configuration as shown, for example in FIGS. 6 to 9. Providing the tweezers as a blank facilitates transportation, supply and storage, and can also produce a tweezer form that is easier to hold and use, by being substantially square in shape.

The tweezer blank 200 includes first and second tweezer arm elements 202, 204, each provided with a tweezer arm 206 each having a respective tweezer tip 208. The preferred embodiments include a finger grip 210, which in the shown embodiment is formed by a series of transversely-extending and spaced ribs disposed in an intermediate position along the extent of both arms 206. In other embodiments finger grips 210 may have other configurations, such as a roughened or textured surface. The arm elements 202, 204 also each include a tweezer body panel 212, 214, each being generally rectangular in plan view and described in further detail below.

Attached between the two tweezer arm elements 202,204 is a body panel element 220, also substantially rectangular or square form, while attached to one of the tweezer arms is a second body panel element 222, again of generally rectangular or square form.

In this embodiment, attached to the body panel element 220 is a lid or top panel 230, also of substantially rectangular or square form, at which comprises a lens 232.

In the preferred embodiments, the tweezer blank 200 is formed of a single, that is unitary, material, particularly flexible plastics material, such as polypropylene or similar material which has good flexibility characteristics, enabling the provision of hinged zones between the various components of the tweezer form, these being shown at 240 in FIG. 6.

The tweezer arms 206 taper gently so as to narrow towards the tweezer tips 208, in a manner which is generally known in the art.

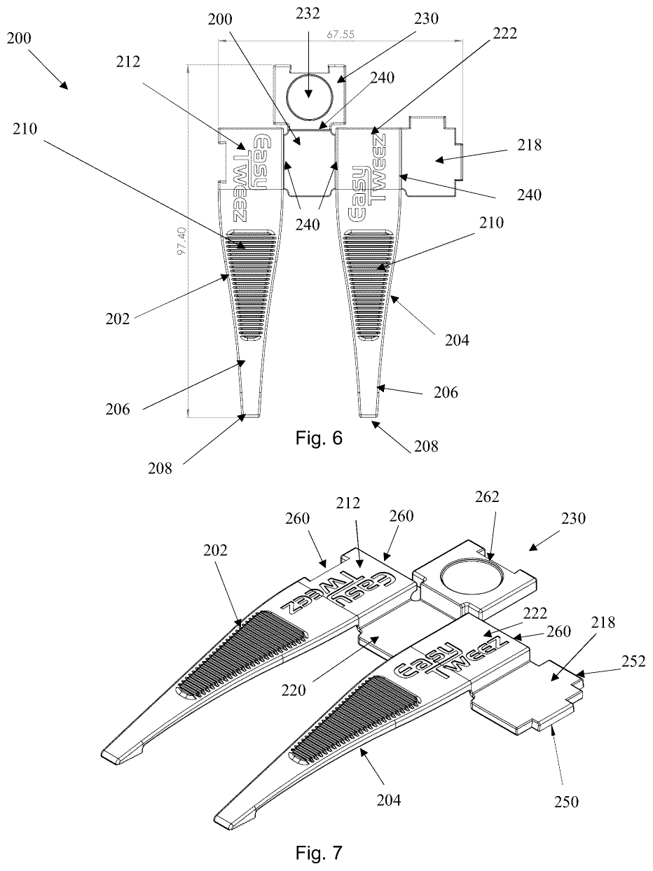

Referring now to FIG. 7, this shows a perspective view of the tweezer blank 200 of FIG. 6 and some further features of the device.

The body panel 218 includes a first fixation tab 250 disposed in a lateral location of the panel 218 and a second fixation tab 252 located at an upper side of the panel 218. The lateral tab 250 is shaped and sized to fit within a lateral recess or slot 260 in the opposing tweezer arm 202. In practice, the tab 250 and recess 260 are preferably shaped and sized so that they can click together so as to secure the tweezer blank into a closed, in-use, configuration. It is preferred that the tab 250 and recess or slot 260 are a snap-fit, although in other embodies they may be a friction fit. A snap-fit may be achieved by a configuration similar to a dovetail joint.

The upper tab 252 is sized and shaped to fit into a corresponding recess or slot 262 in the top panel 230 and these may have similar features as the tab 250 and recess 260 described above.

The body portions 212, 222 of the arm elements 202, 204 preferably have a thickness sufficient to create an abutment surface 260 at an upper end of these elements, for purpose as described below.

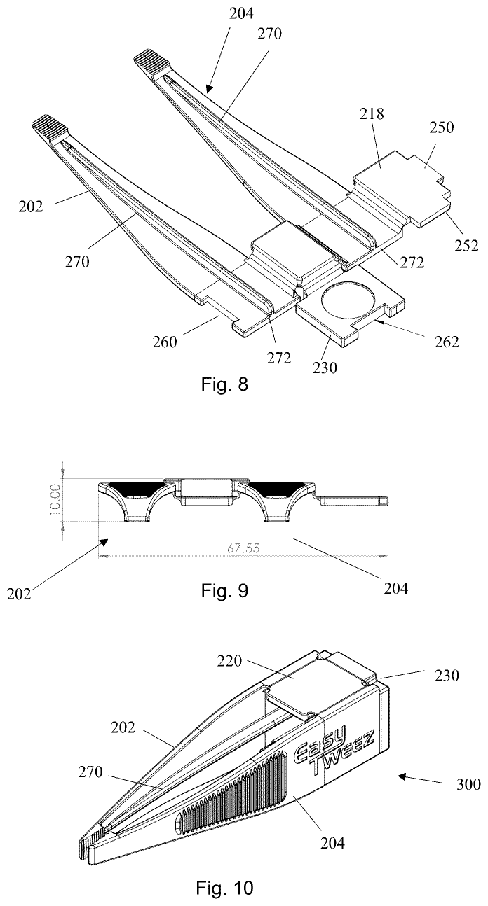

Referring now to FIG. 8, it can be seen that extending along the internal surface of each tweezer arm 202, 204 is a rib 270. In this embodiment each rib 270 is generally centred along each tweezer arm 202, 204. Each rib 270 has, in this embodiment, a generally uniform width and at its upper end, adjacent the lid member 230 provides a shoulder 272, which acts as a support to the lid member 230, as described in further detail below. Each rib 270 extends towards the tip 208 of the tweezer arms 202, 204 and in the preferred embodiment has a height that tapers gradually along the length of each arm 202, 204 so as to have no or virtually no height at the tweezer tips 208. In the embodiment shown in FIG. 8, the distal end of each rib 270 tapers at a greater angle at a point close to tweezer tips or pads 290.

The ribs 270 have plurality of functions, described in further detail below.

Referring to the view of FIG. 9, this shows an end elevational view of the tweezer form of FIGS. 6 to 8, also in the flattened or open condition, and showing the tips of the tweezers curving downwardly, in the view of FIG. 9, so as in practice to be able to curve towards one another when the tweezers are in their made-up, closed, configuration.

FIGS. 6, 9 and 11 to 14 show some indicative dimensions, in millimetres, of a practical embodiment of tweezers. It is to be understood that these are just an example as the tweezers could be made to any desired size.

Referring now to FIG. 10, this shows the tweezer blank of FIGS. 6 to 9 in the closed, or assembled, form. As can be seen, the blank forms a tweezer body 300 which is substantially square in this embodiment, as a result of the shape and configuration of the various elements of the tweezer blank. The cover or lid 230 preferably overlies the distal ends of the tweezer arms 202, 204 and of the body panels 210, 224, such as the latter provide support at all four edges of the top or lid panel 230. Added to the coupling of the tabs in the respective recesses or slots, this arrangement creates a strong and solid body portion to the tweezers. The inner ribs 270, of which one can be seen in FIG. 10, provide a further support to the lid panel 230 by means of the stop shoulder at their upper ends, although this is not strictly necessary given the support characteristics of the side wall panels forming the body of the tweezers.

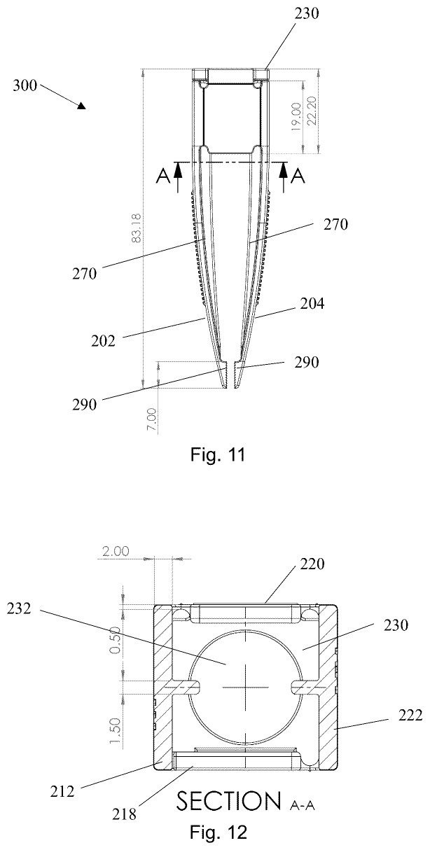

Referring to FIG. 11, this shows a side elevational view of the closed tweezers 300 of FIG. 10, where the curvature of the arms 202, 204 can be readily seen, as can the taper of the internal ribs 270. While in the embodiment shown the ribs 270 have no or negligible height at the location of the pads 290 of the arms 202, 204, in other embodiments the ribs may continue to the pads 290 may have a height consistent with that of the pads 290. The ribs 270, and their taper provides strength to the tweezer arms and variable flexibility along the length of the arms, facilitating accurate control and manipulation of the tweezers 200 by a person.

Referring now to FIG. 12, this is a cross-sectional view across line A-A of FIG. 11, in which it can be seen at the side wall panels of the body portion of the tweezers 200 form a square shape (although could be rectangular in other embodiments), having a shape and size consistent with the lid panel 230, such that the lid panel 230 rests on these ends of the panels 212-222. As explained above, the upper surface of each rib 270 can in some embodiments also act as a supporting shoulder to add to the support of the cap or lid panel 230. In some embodiments, the shoulders of the ribs 270 may also act to support the edges of the lens 232, to ensure that the lens remains properly positioned and aligned with respect to the tips of the tweezer arms 202, 204.

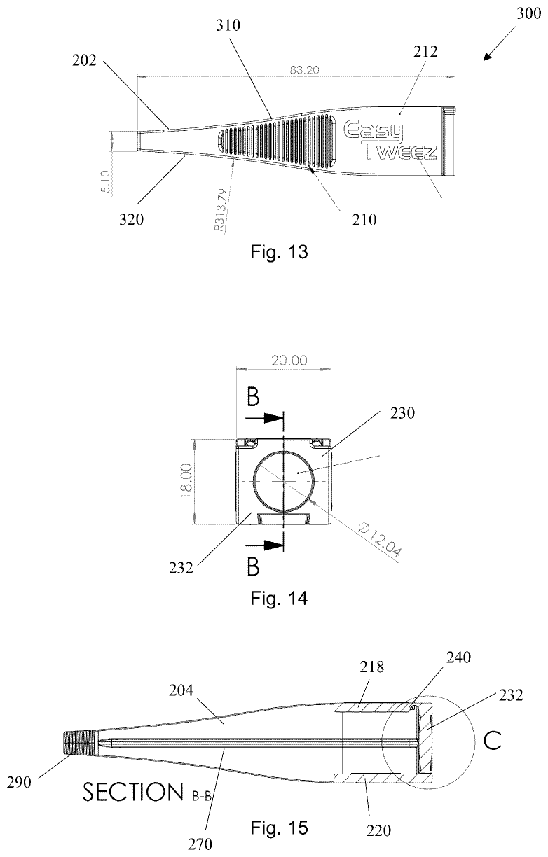

Referring now to FIG. 13, this shows a side elevational review of the tweezers 300 in the closed configuration. It can be readily seen that the cover or lid panel 230 overlies the distal ends of the body panels forming the tweezer body. It can also be seen in FIG. 13 that the arms 202, 204 preferably taper in such a manner as to have a section 310 which with a concave taper, which then returns to a generally straight generally uniform taper 320 adjacent the ends of the tweezer arms. A concave taper of the nature shown in FIG. 13 can ensure a rapid reduction in stiffness of the tweezer arms and greater control of the tweezers by a user.

FIG. 14 shows a top elevational view of the assembly of FIG. 13 with the lid panel 230 in position.

Referring to the cross-sectional view of FIG. 15, taken along line B-B of FIG. 14, in this embodiment the lens 230 is formed integrally with the cover or lid panel 230. In other embodiments lens 232 may be formed separately and then fixed into a circular aperture in the lid panel 230 and preferably fixed in place by a snap-fit connection or similar. Having a separate lens 232 enables the lens to be made of a different material and the body of the tweezer form, such as a poly carbonate or other rigid material which can be very precisely formed.

FIG. 15 also shows one of the live hinges 240 between the body panel 220 and the lid panel 230.

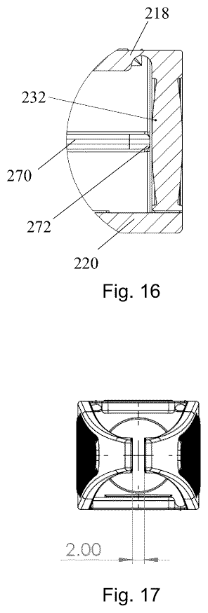

FIG. 16 shows an enlarged view of the upper end of the tweezer form and particularly of the lid 230 and lens 232.

It will be appreciated that in the embodiment of FIGS. 15 and 16 the cover panel 230 does not lie on top of the side wall panel 220, this being another version, and relies on the shoulders 272 of the ribs 270 for support.

Referring to FIG. 17, this shows an end elevational view of the tweezers, at the tips 208 of the tweezer arms 202, 204 and how these curve towards one another at the centre line of the tweezer form and particularly, preferably, at the centre of the lens 232. In this embodiment the arm tips are spaced form one another by around 2 millimetres, although this is a mater of choice.

The lens 232 is preferably chosen to have a focal length the same of that as the length of the arms 202, 204 so as to provide perfect focus at the tips 208 of the arms 202, 204. There is a clear line of sight from the lens 232 to the arm tips 208, facilitated also by the tapering nature of the internal ribs 270, which might otherwise interrupt that clear line of sight.

The tweezer form shown in FIGS. 6 to 17 can commence as a flatform, useful for transportation, postage, packing and so on, and can then be made up into the three dimensional form, which is solid, strong and very usable as a pair of tweezers. The ability to open and close the form shown in FIGS. 6 to 9 in particular enables also the tweezers to be made substantially larger than conventional tweezers because of the ability to open them out transport them in a flattened configuration. This will therefore enable a provision of larger tweezers compared to the prior art, especially in practical terms.

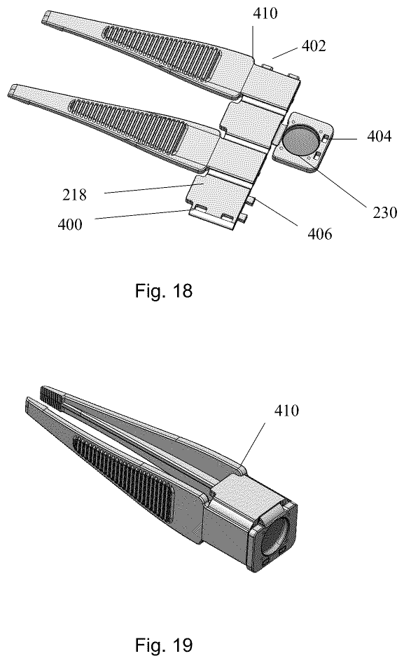

FIGS. 18 and 19 show another embodiment of tweezers very similar to the above described embodiment of FIGS. 6 to 17 and comprising the following primary differences. The side panel 218 comprise a pair of slots for receiving a pair of bosses 402, preferably in a snap-fit manner. Similarly the cover panel 230 is provided with a pair of slots 406 receivable in a pair of bosses 404 in the side panel 218. Additionally, the tweezer arms are provided with wider shoulders 410, such that the arms are generally wider that the body portion of the tweezers, which hold the lens, making easier for a person to hold and operate the tweezers.

The manufacture of the tweezers is also facilitated by this configuration, for example in the case where the lens 232 is made as a separate component, it can be fitted into the aperture in the lid panel 230 with the whole assembly in flattened form, thereby enabling the application of significant pressure without risking damaging the tweezer arms or any other part of the tweezer assembly.

The preferred material for the body of the tweezer assemblies polypropylene as this has good flexibility for the live hinges 240 and yet also substantial strength and rigidity for the body of the tweezers. Other materials can be chosen by the person skilled in the art if so desired. The lens 232 is preferably (although not necessarily) made of a different material, such as polycarbonate.

In some embodiments, the tweezer assembly may be formed of a material impregnated with an antibacterial agent, while in other embodiments may be provided with a coating of antibacterial agent.

While the described embodiments use the same material for the main structure of the tweezers, in other embodiments the main structure could be formed of a plurality of materials. For example, the hinges could be made of a more compliant material than the body panels, the tweezer arms could be made of a more flexible material than the body panels, and so on. Such alternatives can be achieved in a single manufacturing process, for example injection, moulding or casting process.

According to further embodiments, there may be more than four side panels forming the body of the tweezers, provided that, when arranged for use, they fold to form a hollow body capable of supporting the compressive force applied by a hand pinching the tweezer arms. Having four side panels at right angles to one another is preferred, as when-configured, the side panels at right angles to the tweezer legs provide an inherent force against the force applied by a user pinching the tweezer legs. For example, six side panels would form a tweezer body of substantially hexagonal transverse cross-section. Some embodiments may include side panels with curved transverse cross-sections.

The product and process disclosed herein provide a tweezer assembly that can, with or without the lens, be manufactured as a single substantially flat sheet component, which enables time, material and potentially cost effective methods such as injection moulding or additive manufacturing to be employed.

A tweezer assembly as described in the disclosed embodiments provides easy configuring to a three dimensional in-use form and easy decoupling back to a substantially flat form. Due to the intuitive ease of assembly, the tweezers may be sold in unconfigured form, being packaged substantially flat and delivered in a letter-shaped package, with the final product configured for use by the end user.

The tweezers may be disposable, so designed for single use, although, as explained, may be able to be cleaned for reuse, in which case being able to open them out again for cleaning is a significant advantage.

Being able to supply the tweezers in a flat format also significantly saves or shipping and storage volume, making them cheaper to make, transport and store.

It will be appreciated that described above are only embodiments of the present invention and the skilled person will appreciate that modifications may be made to the described embodiments in a manner to be evident to the skilled person.

I claim:

1. A pair of tweezers provided as a substantially flat form comprising at least four adjacent side wall panels hinged to each other, first and second tweezer arms each extending from a respective side panel, and a lid panel hinged or attachable to at least one side panel, the lid panel comprising a magnifying lens;
the side wall panels being closable to form a three dimensional tweezer body member with the tweezer arms at opposite sides of the body member and with the lid panel disposed over the side wall panels and in an orientation substantially orthogonal to a longitudinal axis of the tweezers, the magnifying lens having an axis of focus substantially aligned with the longitudinal axis of the tweezers and a focal point at or adjacent ends of the tweezer arms.

2. The pair of tweezers according to claim 1, wherein the lens is one of integral with and attached to the lid panel.

3. The pair of tweezers according to claim 1, wherein the side wall panels are formed integrally together in side-by-side arrangement, two of the side panels being respective ends of the side-by-side arrangement and each having an unconnected edge, each unconnected edge comprising an attachment feature such that the two end panels can be connected together.

4. The pair of tweezers according to claim 3, wherein adjacent side wall panels are connected to one another by a foldable coupling.

5. The pair of tweezers according to claim 4, wherein each foldable coupling is formed by a bendable part of material forming the tweezer body.

6. The pair of tweezers according to claim 1, wherein the lens is attachable to the cap and the assembly comprises a plurality of lenses of different focal magnifying power, one of which is selectable to attachment to the cap.

7. The pair of tweezers according to claim 1, wherein the lid panel and the lens are integral with one another.

8. The pair of tweezers according to claim 1, comprising a finger grip at an outer surface of each tweezer arm.

9. The pair of tweezers according to claim 1, wherein the side wall panels and tweezer arms are formed as a unitary component.

10. The pair of tweezers according to claim 1, wherein the tweezer body is one of substantially square and substantially rectangular in transverse cross-section.

11. The pair of tweezers according to claim 1, wherein the first and second longitudinal axis of the tweezers extend substantially parallel to one another when in the assembled form.

12. The pair of tweezers according to claim 1, wherein the first and second longitudinal axis of the tweezers taper towards one another.

13. The pair of tweezers according to claim 1, wherein the first and second longitudinal axis of the tweezers curve towards one another.

14. The pair of tweezers according to claim 1, wherein each tweezer arm comprises an internal rib extending in a longitudinal direction of the tweezer arm.

15. The pair of tweezers according to claim 14, wherein each internal rib tapers from the tweezer body to the tip of the tweezer arm.

16. The pair of tweezers according to claim 14, wherein each internal rib comprises an upper shoulder able to support the lid panel.

17. The pair of tweezers according to claim 1, wherein the side wall panels are releasably connectable to one another, allowing the tweezers to be opened up to the flat configuration.

18. The pair of tweezers according to claim 1, incorporating or coated with an anti-bacterial agent.

19. A pair of tweezers provided as a substantially flat form comprising at least four adjacent side wall panels hinged to each other, first and second tweezer arms each extending from a respective side panel, and a lid panel hinged or attachable to at least one side panel, the lid panel comprising a magnifying lens integral with the lid panel; the side wall panels being closable to form a three dimensional tweezer body member with the tweezer arms at opposite sides of the body member and with the lid panel disposed over the side wall panels and in an orientation substantially orthogonal to a longitudinal axis of the tweezers, the side wall panels being formed integrally together in side-by-side arrangement, two of the side panels being respective ends of the side-by-side arrangement and each having an unconnected edge, each unconnected edge comprising an attachment feature such that the two end panels can be connected together, the side wall panels and tweezer arms being formed as a unitary component; the magnifying lens having an axis of focus substantially aligned with the longitudinal axis of the tweezers and a focal point at or adjacent ends of the tweezer arms.

20. The pair of tweezers according to claim 19, wherein each tweezer arm comprises an internal rib extending in a longitudinal direction of the tweezer arm, and wherein each internal rib tapers from the tweezer body to the tip of the tweezer arm and comprises an upper shoulder able to support the lid panel.
